(19) United States
(12) Patent Application Publication
(10) Pub. No.: US 2026/0205399 A1
(43) Pub. Date: Jul. 16, 2026

(54) METHOD FOR ESTIMATING A LOAD OF A BEAM FORMED IN A CELL OF A WIRELESS CELLULAR ACCESS NETWORK

(71) Applicant: Orange, Issy-Les-Moulineaux (FR)

(72) Inventors: Antoine DEJONGHE, Chatillon Cedex (FR); Safaa DRIOUECH, Chatillon Cedex (FR); Zwi ALTMAN, Chatillon Cedex (FR)

(21) Appl. No.: 19/138,078

(22) PCT Filed: Dec. 18, 2023
(86) PCT No.: PCT/EP2023/086255

§ 371 Date: Jun. 11, 2025

(30) Foreign Application Priority Data
Dec. 19, 2022 (FR) FR2213868

(51) Int. Cl. H04L 43/0882; H04W 16/28; H04W 28/082

(52) U.S. Cl. CPC H04L 43/0882; H04W 16/28; H04W 28/082

(57) ABSTRACT

A method for the estimation, by a control device of a wireless cellular access network, of a load of a beam of interest among a plurality of beams that can be formed to serve user terminals in a cell of the wireless cellular access network, the method for estimation including: determining a load indicator M_{E}(T) of the cell for a time window T, based on information regarding a use of communication resources throughout the cell, during the time window, determining a load indicator M_{b}(T) for the beam of interest for the time window T, based on information regarding a use of communication resources in the beam of interest, during the time window, and estimating the load of the beam of interest, based on the product M_{E}(T)×M_{b}(T).

### CROSS-REFERENCE TO RELATED APPLICATIONS

This application is filed under 35 U.S.C. § 371 as the U.S. National Phase of Application No. PCT/EP2023/086255 entitled “Method for estimating a load of a beam formed in a cell of a wireless cellular access network” and filed Dec. 18, 2023, and which claims priority to FR2213868 filed Dec. 19, 2022, each of which is incorporated by reference in its entirety.

### BACKGROUND

### Field

The present development lies within the field of communication systems, and more particularly relates to a method for estimating a load of a beam of interest among a plurality of beams formed in a cell of a wireless cellular access network, as well as methods for configuring communications between the wireless cellular access network and a user terminal, by using estimated beam loads.

### Description of the Related Technology

It is provided, in current and future wireless cellular communication systems, to form a plurality of beams within each cell. To this end, a base station is typically equipped with a plurality of antennas. By applying respective complex coefficients to the different antennas of the base station, it is possible to form different beams, i.e. to form different radiation patterns which allow, for example, spatial multiplexing of different user terminals within a same cell.

When the number of antennas becomes large, this is referred to as a massive multi-antenna system or massive MIMO (where MIMO stands for Multiple Input Multiple Output). Such massive MIMO systems are taken into account in 5G and subsequent communication systems in particular.

In such massive MIMO systems, it is possible, for example, to use a grid of beams (GoB). Such GoBs are widely used in industry for control channels and/or data channels. The beams in a GoB are not adaptive, meaning they are not specifically optimized to exchange data with a specific user terminal, but rather to serve specific geographical areas within the cell. Adaptive beamforming is also possible, particularly for data channels (for example using techniques known as “eigen-based beamforming” in the literature).

By using beamforming, the performance and quality of service (QoS) indicators can be defined with greater resolution, at the beam scale. In particular, load, which is a central indicator for wireless access networks, can be defined per beam.

Various definitions have been proposed to estimate the load of a beam of interest. For example, the 3GPP TS 38.423 V17.1.0 technical specification defines a function for estimating the load of a beam of interest, which corresponds to a ratio between the number of physical resource blocks (PRBs in the 3GPP specifications) used by the beam of interest and the number of PRBs used by all beams included in the cell:

$$\frac{{\sum }_{i = 1}^{L} {\text{?}}_{b}^{i} {N}_{PRB , b}^{i}}{{\sum }_{i = 1}^{L} {\sum }_{{b}^{′} = 1}^{B} {\text{?}}_{{b}^{′}}^{i} {N}_{P RB , {b}^{′}}^{i}} \qquad [ Math . 1 ]$$

an expression in which:
B corresponds to the number of beams (for example of a GoB),
L corresponds to the number of successive time intervals (“slots” or “mini-slots” in the 3GPP specifications) considered in estimating the load of the beam of interest b,

$${\text{?}}_{{b}^{′}}^{i}$$

corresponds to an indicator function which is equal to 1 if the beam b′ (1≤b′≤B) is activated over the time interval i (1≤i≤L), and otherwise is 0,

$${N}_{P RB , {b}^{′}}^{i}$$

corresponds to the number of PRBs used in the beam b′ (1≤b′≤B) during the time interval i (1≤i≤L) (it should be noted that, in the 3GPP specifications, the number

$${N}_{P RB , {b}^{′}}^{i}$$

is the same for all beams of a cell which are activated simultaneously, i.e.

$${N}_{P RB , {b}^{′}}^{i} = {N}_{P R B}^{i} ∀ {b}^{′} ) .$$

However, such a function for estimating the load of a beam of interest is not robust. Indeed, this estimation function is based on the use of communication resources (PRBs) in the beam of interest, and the communication resources are actually used only when the beam of interest is activated (scheduled). Thus, if the beam of interest is rarely activated, then the estimated load of this beam of interest will be low, so this beam of interest could be considered as capable of carrying more traffic. However, the usable communication resources (PRB) are allocated to the entire cell. Therefore, the beam of interest may, very rarely, be activated even when it has a lot of traffic to carry, because the other beams of the cell also have a lot of traffic to carry using the same communication resources. Indeed, activations of the beam of interest are then more spaced out over time, to allow the other beams also having traffic to carry to be activated more often. In such a case, the load of the beam of interest, estimated with the above estimation function, would be low even though this beam of interest cannot carry more traffic (because it already has a lot of traffic to carry and because it cannot be activated more frequently due to the other beams).

FIG. 1 schematically represents scenarios illustrating the lack of robustness of the estimation function given by the expression [Math. 1]. FIG. 1 schematically represents a cell 12 served by a base station 11 which can form seven (7) different beams 13-1 to 13-7 in this cell 12, for example via a GoB. In FIG. 1, the beam of interest is beam 13-4. In part (a) of FIG. 1, the traffic to be carried by beam 13-4 is significant, and the traffic to be carried in the other beams 13-1 to 13-3, 13-5 to 13-7 is much less than in beam 13-4. In such a case, the load estimated by means of expression [Math. 1] for beam 13-4 is high. In part (b) of FIG. 1, the traffic to be carried by beam 13-4 is unchanged, but the traffic to be carried in the other beams has increased. With expression [Math. 1], the estimated load for beam 13-4 for part b) of FIG. 1 is lower than the load estimated for part a) of FIG. 1, because beam 13-4 is activated less frequently (due to the increase in traffic to be carried in the other beams 13-1 to 13-3, 13-5 to 13-7), even though the traffic to be carried by beam 13-4 has not decreased and the increase in traffic to be carried by the other beams 13-1 to 13-3, 13-5 to 13-7 prevents beam 13-4 from being activated more frequently.

### SUMMARY

This disclosure aims to overcome all or part of the limitations of the prior art solutions, in particular those set forth above, by proposing a solution that makes it possible to improve the estimation of the load of a beam of interest among a plurality of beams formed in a cell of a wireless cellular access network.

To this end, this disclosure relates to a method for the estimation, by a control device of a wireless cellular access network, of a load of a beam of interest among a plurality of beams that may be formed to serve user terminals in a cell of said wireless cellular access network, said method of estimation comprising:
determining a load indicator M_{E}(T) of the cell for a time window T, based on information regarding a use of communication resources throughout the cell, during the time window,
determining a load indicator M_{b}(T) of the beam of interest for the time window T, based on information concerning a use of communication resources in the beam of interest, during the time window,
estimating the load of the beam of interest, based on the product M_{E}(T)×M_{b}(T).

It should be noted that the load indicator M_{E}(T) of the cell and the load indicator M_{b}(T) of the beam of interest, both referred to as “load indicator,” are therefore consistent in the convention adopted for representing the load of the cell and of the beam respectively. In other words, if a high value of the cell load indicator M_{E}(T) of the cell corresponds to a high load level in the cell, then a high value of the load indicator M_{b}(T) of the beam of interest also corresponds to a high load level in the beam of interest.

Thus, the estimated load of the beam of interest takes into account not only a load indicator M_{b}(T) of said beam of interest, but also a load indicator M_{E}(T) of the cell, i.e. of all the beams of said cell. Considering for example that a high value of these load indicators corresponds to a high load level, then, even if the load indicator M_{b}(T) of the beam of interest decreases due to the fact that said beam of interest is activated less frequently, this decrease is offset by the increase in the load indicator M_{E}(T) of the cell. Thus, the product M_{E}(T)×M_{b}(T) may increase if the other beams must carry very heavy traffic, such that the estimated load of the beam of interest is then considered high, which is the expected behavior for the estimation function since the beam of interest does not have the capacity to carry more traffic in this cell of the wireless cellular access network, in the time window.

The proposed solution for estimating the load of a beam of interest, among a plurality of beams formed in a cell, is thus more robust than the prior art solutions. The load of the beam of interest estimated in this manner may be used to improve the performance of certain existing functions, or even to enable the emergence of new functions. For example, the load of the beam of interest may be used by radio resource management (RRM) procedures or by self-organizing network (SON) functions such as:
beam-based mobility robustness optimization (bMRO in the literature)
beam-level mobility load balancing (bMLB).

The bMRO and bMLB functions are the beam-level extension of the cell-level SON functions defined in the 3GPP LTE (4G) specifications, designated MRO and MLB respectively. The loads used for bMRO mobility optimization or for bMLB load distribution are therefore estimated at the beam level and not at the cell level.

In some particular modes of implementation, the method for estimation may optionally further comprise one or more of the following features, individually or in any technically possible combination.

In some particular modes of implementation, the load indicator M_{E}(T) of the cell corresponds to the value of a first function that is monotonic with the use of communication resources throughout the cell, and the load indicator M_{b}(T) of the beam of interest corresponds to the value of a second function, said second function being, at constant use of communication resources in the other beams among the plurality of beams, monotonic with the use of communication resources in the beam of interest, and of the same monotonicity as the first function.

In some particular modes of implementation, determining the load indicator M_{b}(T) of the beam of interest for the time window T comprises determining a level of usage, in the beam of interest, of usable communication resources in the beam of interest during said time window.

In some particular modes of implementation, determining the level of usage of the usable communication resources in the beam of interest during the time window takes into account time intervals during which said beam of interest is activated.

In some particular modes of implementation, the wireless cellular access network uses orthogonal frequency-division multiple access, in which the usable communication resources correspond to physical resource blocks, called PRBs, and the load indicator M_{b}(T) of the beam of interest for the time window T is determined according to the following expression:

$${\sum }_{i = 1}^{L} {\text{?}}_{b}^{i} \frac{{N}_{PRB , b}^{i}}{{N}_{PRB , b}^{max , i}}$$

an expression in which:

$${\text{?}}_{b}^{i}$$

corresponds to an indicator function which is equal to 1 if the beam b of interest is activated in a time interval i of the time window, the time window comprising L time intervals, and which is otherwise equal to 0,

$${N}_{PRB , b}^{i}$$

corresponds to a number of PRBs used in the beam b of interest in the time interval i of the time window,

$${N}_{PRB , b}^{max , i}$$

corresponds to a maximum number of PRBs that can be used in the beam b of interest in the time interval i of the time window.

In some particular modes of implementation, determining the load indicator M_{E}(T) of the cell for the time window T comprises determining a level of usage, in the cell, of usable communication resources in said cell during said time window.

In some particular modes of implementation, the wireless cellular access network uses orthogonal frequency-division multiple access, in which the usable communication resources correspond to physical resource blocks, called PRBs, and the load indicator M_{E}(T) of the cell for the time window T is determined according to the following expression:

$$\frac{{\sum }_{f} f {\sum }_{i}^{L} {R}_{f , i} ( T )}{{\sum }_{i}^{L} {P}_{i} ( T ) LM ( T )}$$

an expression in which:
R_{f,i}(T) corresponds to a number of PRBs multiplexed by each of the f spatial streams over a time interval i of the time window, the time window comprising L time intervals,
Pᵢ(T) corresponds to a maximum number of PRBs that can be used over the time interval i for a single spatial stream in the cell,
LM(T) corresponds to a temporal average, over the time window, of a maximum number of spatial streams that can be used.

In some particular modes of implementation, the load of the beam of interest is determined according to the following expression:

$$\frac{1}{K} ⌊ \frac{{\sum }_{f} f {\sum }_{i}^{L} {R}_{f , i} ( T )}{{\sum }_{i}^{L} {P}_{i} ( T ) LM ( T )} \times K ⌋ \times \frac{1}{L} {\sum }_{i = 1}^{L} {\text{?}}_{b}^{i} \frac{{N}_{PRB , b}^{i}}{{N}_{PRB , b}^{max , i}}$$

with K being a normalizing constant, or according to the following expression:

$$\frac{{\sum }_{f} f {\sum }_{i}^{L} {R}_{f , i} ( T )}{{\sum }_{i}^{L} {P}_{i} ( T ) LM ( T )} \times {\sum }_{i = 1}^{L} {\text{?}}_{b}^{i} \frac{{N}_{PRB , b}^{i}}{{N}_{PRB , b}^{max , i}}$$

According to a second aspect, a method is provided for the configuration, by a control device of a wireless cellular access network, of communications with user terminals, said wireless cellular access network comprising base stations serving a plurality of cells, it being possible to form a plurality of beams in each cell, said method for configuration comprising:
estimating, by implementing a method for estimation according to any one of the modes of implementation of this disclosure, of respective beam loads of cells of the wireless cellular access network,
using the estimated beam loads to configure communications with user terminals.

According to a third aspect, a control device is provided which is included in a wireless cellular access network, said control device comprising at least one memory and at least one processor configured to implement a method for load estimation or a method for configuration according to any one of the embodiments of this disclosure.

According to a fourth aspect, there is provided a wireless cellular access network comprising base stations serving a plurality of base station cells, a plurality of beams being able to be formed in each cell, said wireless cellular access network comprising at least one control device according to any one of the embodiments of this disclosure.

According to a fifth aspect, there is provided a method for the configuration, by a user terminal, of a communication with a wireless cellular access network comprising base stations serving a plurality of base station cells, it being possible to form a plurality of beams in each cell, said method for configuration comprising:
receiving respective beam loads of one or more cells of the wireless cellular access network, said beam loads being estimated by implementing a method for estimation according to any one of the embodiments of this disclosure,
using the estimated beam loads to configure the communication with the wireless cellular access network.

According to a sixth aspect, there is provided a user terminal for exchanging data with a wireless cellular access network, said user terminal comprising at least one memory and at least one processor configured to implement a method for configuration according to any one of the embodiments of this disclosure.

According to a seventh aspect, there is provided a computer program product, comprising a set of program code instructions which, when executed by at least one processor, configure said at least one processor to implement a method according to any one of the embodiments of this disclosure.

### BRIEF DESCRIPTION OF THE DRAWINGS

The development will be better understood by reading the following description, given as a non-limiting example, and made with reference to the figures which represent:

FIG. 1: already described, a schematic representation of two scenarios for beam usage in a cell of a wireless cellular access network,

FIG. 2: a diagram illustrating the main steps of one exemplary implementation of a method for the estimation of the load of a beam of interest,

FIG. 3: a schematic representation of an exemplary embodiment of a control device of a wireless cellular access network, for implementing the method for the estimation of the load of a beam of interest,

FIG. 4: simulation results illustrating the advantages of the method for estimation according to this disclosure,

FIG. 5: a diagram illustrating the main steps of one exemplary implementation of a method for the configuration of communications via a wireless cellular access network,

FIG. 6: a diagram illustrating the main steps of one exemplary implementation of a method for the configuration of communications by a user terminal,

FIG. 7: a schematic representation of one exemplary embodiment of a user terminal.

In these figures, identical references across the figures designate identical or similar elements. For clarity, the elements shown are not to scale, unless otherwise indicated.

Furthermore, the order of steps shown in these figures is given solely as a non-limiting example of this disclosure which may be applied with the same steps being performed in a different order.

### DETAILED DESCRIPTION OF CERTAIN ILLUSTRATIVE EMBODIMENTS

FIG. 2 shows the main steps of a method 20 for the estimation of a load, by a control device 30 of a wireless cellular access network, the load being a load of a beam of interest among a plurality of beams that may be formed to serve user terminals 70 in a cell of said wireless cellular access network.

As illustrated by FIG. 3, the control device 30 comprises for example at least one processor 31 and at least one memory 32 (magnetic hard drive, solid state memory, optical disk, or any type of computer-readable storage medium) in which a computer program product is stored, in the form of a set of program code instructions to be executed in order to carry out all or part of the operations to be carried out by said control device 30. In some cases, the control device 30 may optionally comprise one or more programmable logic circuits (FPGA, PLD, etc.), and/or one or more specialized integrated circuits (ASIC, etc.), and/or a set of discrete electronic components, etc., adapted to carry out all or part of the operations to be carried out by said control device 30. The control device 30 is for example included in one or more base stations 11 and/or is connected to one or more base stations 11 (for example integrated wholly or in part into a radio network controller).

As illustrated in FIG. 2, the method 20 for estimation comprises steps of:
S20 determining a load indicator M_{E}(T) of the cell for a time window T,
S21 determining a load indicator M_{b}(T) of the beam of interest for the time window T,
S22 estimating the load of the beam of interest, based on the load indicator M_{E}(T) of the cell and on the load indicator M_{b}(T) of the beam of interest.

The load indicator M_{E}(T) of the cell 12 is determined, during step S20, based on information regarding a use, during the time window T, of communication resources throughout the cell 12. The load indicator M_{b}(T) of the beam of interest is determined, during step S21, based on information regarding a use, during the time window T, of communication resources in the beam of interest. The information regarding the use of communication resources in the cell or in the beam of interest is for example provided by a scheduler of the wireless cellular access network.

As indicated above, the load indicator M_{E}(T) of the cell and the load indicator M_{b}(T) of the beam of interest, both designated as “load indicator”, are consistent in the convention adopted for representing the load of the cell and of the beam respectively.

In some particular modes of implementation, the load indicator M_{E}(T) of the cell 12 corresponds to the value of a first determined function, and the load indicator M_{b}(T) of the beam of interest corresponds to the value of a second determined function. Where appropriate, the first function is monotonic (i.e. increasing or decreasing) with the use of communication resources throughout the cell. For example, if the first function is increasing, then the load indicator M_{E}(T) of the cell 12 increases with the use of communication resources throughout the cell, i.e. if the use of communication resources throughout the cell is higher during time window T than in a previous time window, then the load indicator M_{E}(T) of the cell 12 determined for time window T is higher than that determined for the previous time window. At constant use of communication resources in the other beams among the plurality of beams, the second function is monotonic with the use of communication resources in the beam of interest. In other words, if the traffic to be carried in the other beams does not vary from one time window to another, then the load indicator M_{b}(T) of the beam of interest is monotonic with the use of communication resources in the beam of interest. For example, if the second function is increasing (respectively decreasing) then, if the use of communication resources in the beam of interest is higher (respectively lower) during the time window T compared to a previous time window, and if in addition the use of resources by the other beams is the same during time window T and during the previous time window, then the load indicator M_{b}(T) of the beam of interest determined for time window T is higher (respectively lower) than that determined for the previous time window.

It should be noted that the second function has the same monotonicity as the first function. In other words, if the first function is an increasing function, then the second function is also an increasing function. Alternatively, if the first function is a decreasing function, then the second function is also a decreasing function. The first function and the second function have the same monotonicity, to ensure that the load indicator M_{E}(T) of the cell 12 and the load indicator M_{b}(T) of the beam of interest are consistent in representing the load. The choice of increasing or decreasing monotonicity for the first and second functions depends on the convention adopted for the load indicator M_{E}(T) of the cell 12 and for the load indicator M_{b}(T) of the beam of interest. Typically, with increasing monotonicity, a high value of the corresponding indicator (M_{E}(T) or M_{b}(T)) corresponds to a high load level. With decreasing monotonicity, a high value of the corresponding indicator (M_{E}(T) or M_{b}(T)) corresponds to a low load level and therefore instead is representative of the capacity for being able to increase the load of the cell or the beam of interest. In the rest of the description, it is considered, in a non-limiting manner, that the first function and the second function are both of increasing monotonicity (for the second function: with constant use of communication resources in the beams other than the beam of interest of the cell).

The estimated load of the beam of interest is determined, during step S22, based on the product M_{E}(T)×M_{b}(T). In the non-limiting example considered, in which the first function and the second function are both increasing, then the load indicator M_{E}(T) of the cell increases when the amount of communication resources used in the other beams increases. Thus, even if the load indicator M_{b}(T) of the beam of interest decreases due to the fact that said beam of interest is activated less often, this decrease is offset by the increase in the load indicator M_{E}(T) of the cell. Thus, the product M_{E}(T)×M_{b}(T) can increase if the other beams have to carry more traffic, such that the estimated load of the beam of interest is then considered high, which is the expected behavior for the estimation function since the beam of interest does not have the capacity to carry more traffic in this cell, in the time window.

It should be noted that the product M_{E}(T)×M_{b}(T) is used while considering a linear scale, and that such a product becomes a sum if a logarithmic scale is considered. In other words, (M_{E}(T)×M_{b}(T))_{dB}=(M_{E}(T))_{dB}+(M_{b}(T))_{dB}.

In the remainder of the description, we consider, in a non-limiting manner, the case where the wireless cellular access network uses orthogonal frequency-division multiple access, known as OFDMA, in which the usable communication resources correspond to physical resource blocks, known as PRBs. 4G and 5G wireless cellular communication systems, in particular, are OFDMA systems. In 4G communication systems, the PRBs correspond to time-frequency blocks, each PRB extending over a time interval of 0.5 ms (“slot” in the 3GPP 4G specifications, which comprises 7 OFDM symbols) and over 12 subcarriers (“subcarriers” in the 3GPP specifications). In 5G communication systems, PRBs correspond to frequency blocks of 12 subcarriers, it being possible to allocate each PRB over a time interval (“slot” or “mini-slot” in the 3GPP 5G specifications) of variable duration which depends in particular on the spacing between the subcarriers. For example, if the time interval corresponds to a “slot”, the duration of the time interval is between 0.125 ms (for a spacing of 120 kHz between subcarriers) and 1 ms (for a spacing of 15 kHz between subcarriers). It is also considered, in a non-limiting manner, that the beams in a same cell cannot all be activated simultaneously.

We now provide non-limiting examples of some expressions for the load indicator M_{E}(T) of the cell and for the load indicator M_{b}(T) of the beam of interest.

In some particular modes of implementation, the load indicator M_{E}(T) of the cell for the time window T is for example representative of a level of usage, in the cell, of usable communication resources in the cell during said time window T. For example, this level of usage may be determined according to the following expression:

$$\frac{{\sum }_{f} f {\sum }_{i}^{L} {R}_{f , i} ( T )}{{\sum }_{i}^{L} {P}_{i} ( T ) LM ( T )} \qquad [ Math . 2 ]$$

The expression [Math. 2] considers the same notations as those used in section 5.1.1.2.11 of the 3GPP TS 28.552 V17.7.1 specification for the indicator “PDSCH PRB usage per cell for MIMO”. More specifically.
R_{f,i}(T) corresponds to a number of PRBs multiplexed by each of the f spatial streams (also known as “spatial layers” in the literature, “MIMO layers” in the 3GPP TS 28.552 V17.7.1 specification) over a time interval i (“slot” or “mini-slot”) of the time window, the time window T comprising L time intervals; if, for example, there are only two spatial streams (f=2) over the time interval i of the time window T, then all R_{f,i}(T) are zero except R_{2,i}(T),
Pᵢ(T) corresponds to a maximum number of PRBs that can be used over the time interval i for a single spatial stream in the cell,
LM(T) corresponds to a temporal average, over the time window, of a maximum number of spatial streams that can be used.

For example, it is possible to use the same expression as given in the 3GPP TS 28.552 V17.7.1 specification, namely:

$${M}_{E} ( T ) = ⌊ \frac{{\sum }_{f} f {\sum }_{i}^{L} {R}_{f , i} ( T )}{{\sum }_{i}^{L} {P}_{i} ( T ) L M ( T )} \times 100 ⌋$$

or a normalized value:

$${M}_{E} ( T ) = \frac{1}{100} ⌊ \frac{{\sum }_{f} f {\sum }_{i}^{L} {R}_{f , i} ( T )}{{\sum }_{i}^{L} {P}_{i} ( T ) L M ( T )} \times 100 ⌋$$

an expression in which └x┘ corresponds to the integer part of x.

More generally, the load indicator M_{E}(T) of the cell is for example given by the expression:

$${M}_{E} ( T ) = \frac{1}{K} ⌊ \frac{{\sum }_{f} f {\sum }_{i}^{L} {R}_{f , i} ( T )}{{\sum }_{i}^{L} {P}_{i} ( T ) L M ( T )} \times K ⌋$$

an expression in which K corresponds to a determined coefficient, preferably an integer, or more simply it is given by or determined as a function of the expression:

$${M}_{E} ( T ) = \frac{{\sum }_{f} f {\sum }_{i}^{L} {R}_{f , i} ( T )}{{\sum }_{i}^{L} {P}_{i} ( T ) L M ( T )}$$

However, other expressions are possible for the load indicator M_{E}(T) of the cell 12, and in particular any form that is based on a first function that is monotonic with the use of the communication resources in the cell, and the choice of a particular type of first function corresponds only to a variant implementation.

In some particular modes of implementation, the load indicator M_{b}(T) of the beam of interest for the time window T is representative of a level of usage, in the beam of interest, of usable communication resources in the beam of interest during said time window. Preferably, the level of usage of the usable communication resources in the beam of interest during the time window takes into account the time intervals during which said beam of interest is activated. For example, this level of usage may be determined according to the following expression:

$${\sum }_{i = 1}^{L} {\text{?}}_{b}^{i} \frac{{N}_{PRB , b}^{i}}{{N}_{PRB , b}^{max , i}} \qquad [ Math . 3 ]$$

an expression in which:

$${\text{?}}_{b}^{i}$$

corresponds to an indicator function which is equal to 1 if the beam b of interest is activated over a time interval i (“slot” or “mini-slot”) of the time window, the time window comprising L time intervals, and which is equal to 0 otherwise,

$${N}_{PRB , b}^{i}$$

corresponds to a number of PRBs used in the beam b of interest over the time interval i of the time window,

$${N}_{PRB , b}^{max , i}$$

corresponds to a maximum number of PRBs that can be used in the beam b of interest over the time interval i of the time window.

It should be noted that in the 3GPP specifications, the number

$${N}_{PRB , b}^{i}$$

is the same for all beams of a same cell activated simultaneously, i.e.

$${N}_{PRB , b}^{i} = {N}_{PRB}^{i} ∀ b .$$

Similarly, in the 3GPP specifications, the number

$${N}_{PRB , b}^{max , i}$$

is the same for all beams of a same cell activated simultaneously, i.e.

$${N}_{PRB , b}^{max , i} = {N}_{PRB}^{max , i} ∀ b .$$

It is therefore also possible, in certain implementations, to have in expression [Math. 3] the same number

$${N}_{PRB , b}^{i}$$

and the same number

$${N}_{PRB , b}^{max , i}$$

for all beams of a same cell which are activated simultaneously. In such a case, in expression [Math. 3], the use of communication resources by the other beams of the cell (other than the beam b of interest) essentially influences the indicator functions

$${\text{?}}_{b}^{i}$$

of the beam b of interest.

For example, it is possible to determine the load indicator M_{b}(T) of the beam b of interest according to the following expression:

$${M}_{b} ( T ) = \frac{1}{L} {\sum }_{i = 1}^{L} {\text{?}}_{b}^{i} \frac{{N}_{PRB}^{i}}{{N}_{PRB}^{max , i}}$$

or more simply according to the following expression:

$${M}_{b} ( T ) = \frac{1}{L} {\sum }_{i = 1}^{L} {\text{?}}_{b}^{i} \frac{{N}_{PRB}^{i}}{{N}_{PRB}^{max , i}}$$

However, other expressions are possible for the load indicator M_{b}(T) of the beam b of interest, and in particular any form based on a second function that is monotonic with the use of communication resources in the beam of interest, at constant use of communication resources in the other beams, and the choice of a particular type of second function corresponds only to a variant implementation.

The estimated load is determined based on the product M_{E}(T)×M_{b}(T), which may be determined, for example, by considering any combination of the expressions for M_{E}(T) and M_{b}(T) given above.

We now provide simulation results demonstrating the improvement in the robustness of the estimated load compared to prior art solutions, and more particularly compared to the prior art solution based on the above expression [Math. 1]. For the purposes of comparison, the estimated load of the beam b of interest, hereinafter referred to as ρ_{b}(T), was determined using, in a non-limiting manner, the following expression, which corresponds to a preferred mode of implementation:

$${ρ}_{b} ( T ) = \frac{1}{100} ⌊ \frac{{\sum }_{f} f {\sum }_{i}^{L} {R}_{f , i} ( T )}{{\sum }_{i}^{L} {P}_{i} ( T ) L M ( T )} \times 100 ⌋ \times \frac{1}{L} {\sum }_{i = 1}^{L} {\text{?}}_{b}^{i} \frac{{N}_{PRB}^{i}}{{N}_{PRB}^{max , i}} \qquad [ Math . 4 ]$$

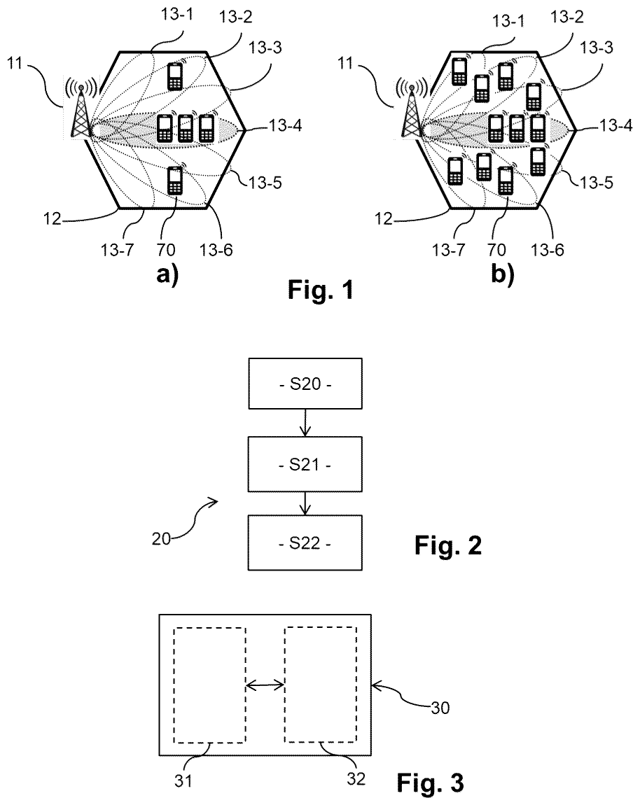

The simulations were carried out by considering a uniform deployment of 7 tri-sector base stations 11 in a macro urban environment (inter-base station 11 distance of about 300 m). In these simulations, each cell is served by an 8×8 antenna array and serves the user terminals 70 by means of a GoB forming 7 beams, similar to those shown in FIG. 1. The multiplexing technique used is OFDMA. For these simulations, a traffic model called File Transfer Protocol (FTP) was also considered, in which user terminals 70 come into the wireless cellular access network according to a Poisson process. These user terminals 70 must download a 10 MB file and leave the wireless cellular access network when the download is complete. The user terminals 70 attached to a same cell were scheduled using a Proportional-Fair (PF) scheduler. In addition, the propagation conditions between the user terminals 70 and the base stations 11 were simulated by using the 3GPP channel model.

In the following, we evaluate the performance of a cell 12 located at the center of the wireless cellular access network. For this cell 12, we consider different arrival rates of user terminals 70 in the coverage areas of the GoB beams. Specifically, we consider two arrival rate patterns:
First arrival rate pattern: 0.2 user terminals arrive per second in the coverage area of beams 13-1, 13-2, 13-4, 13-5, and 13-7, while 1.3 user terminals arrive per second in the coverage area of beams 13-3 and 13-6,
Second arrival rate pattern: 0.5 user terminals 70 arrive per second in the coverage area of beams 13-1, 13-2, 13-4, 13-5, and 13-7, while 1.3 user terminals arrive per second in the coverage area of beams 13-3 and 13-6.

It should be noted that the first and second arrival rate patterns allow the scenarios respectively represented in parts a) and b) of FIG. 1 to be simulated. Indeed, the traffic demand is high for beams 13-3 and 13-6 and does not increase between the first arrival rate pattern and the second arrival rate pattern, whereas the traffic demand increases for beams 13-1, 13-2, 13-4, 13-5 and 13-7 between the first arrival rate pattern and the second arrival rate pattern.

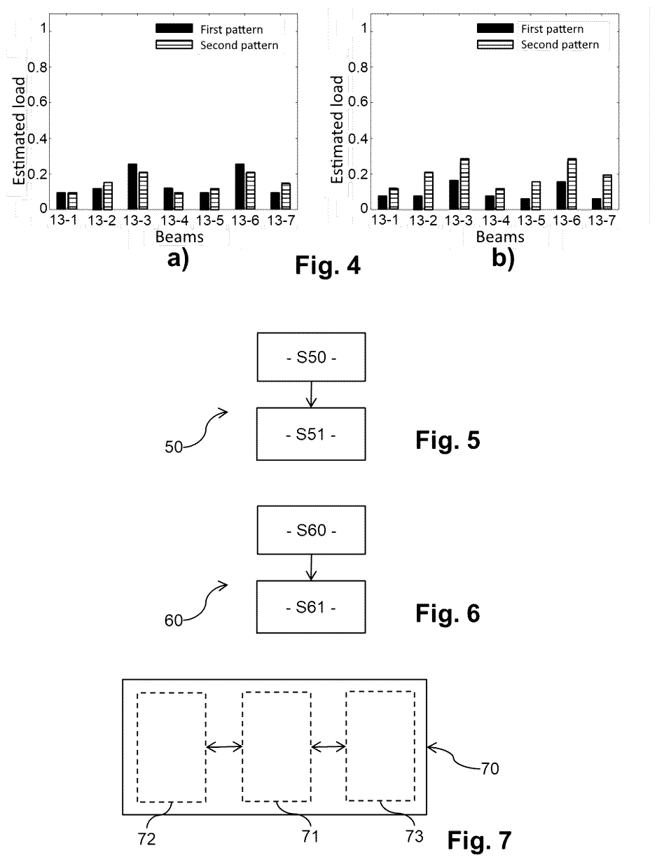

FIG. 4 schematically represents the results obtained in terms of estimated load. More particularly, part a) of FIG. 4 represents the estimated loads, using expression [Math. 1] of the prior art and a time window of 20 seconds, for the first arrival rate pattern and the second arrival rate pattern. Part b) of FIG. 4 represents the estimated loads, using expression [Math. 4] above, for the first arrival rate pattern and the second arrival rate pattern.

As illustrated by part a) of FIG. 4, when moving from the first to the second arrival rate pattern, we observe an overall increase in the loads of beams 13-1, 13-2, 13-4, 13-5 and 13-7, while the estimated loads of beams 13-3 and 13-6 decrease. This illustrates the lack of robustness of the estimation function [Math. 1].

As illustrated by part b) of FIG. 4, when moving from the first to the second arrival rate pattern, we observe a significant increase in the estimated loads of all beams, which demonstrates the robustness of the estimation function of the proposed expression [Math. 4].

FIG. 5 represents the main steps of a method 50 for a configuration, by a control device 30 of a wireless cellular access network, of communications with user terminals 70. As illustrated by FIG. 5, said method for configuration comprises the following steps:
S50 estimating, by implementing a method 20 for the estimation of a beam load, respective beam loads of cells of the wireless cellular access network,
S51 using the estimated beam loads to configure the communications with user terminals 70.

As indicated above, the configuration of communications by the wireless cellular access network corresponds, for example, to carrying out at least one of the following:
managing the communication resources of the wireless cellular access network (for example, in the context of RRM procedures),
managing user terminal mobility (for example, in the context of bMRO type SON functions),
distributing loads between beams of a same cell and/or between beams of different cells (for example, in the context of bMLB type SON functions).

The loads estimated using the method 20 for estimation may be implemented, on the wireless cellular access network side, in order to improve the performance of certain functions used in the wireless communication systems, or even to allow the emergence of new functions. However, it should be noted that such estimated loads, in particular because they are more robust than those estimated in the prior art, may also be used on the user terminal 70 side.

FIG. 6 represents the main steps of a method 60 for the configuration, by a user terminal 70, of a communication with a wireless cellular access network.

As illustrated in FIG. 7, the user terminal 70 comprises for example at least one processor 71 and at least one memory 72 (magnetic hard drive, solid-state memory, optical disk, or any type of computer-readable storage medium) in which a computer program product is stored, in the form of a set of program code instructions to be executed in order to perform all or part of the operations to be performed by said user terminal 70. In certain cases, the user terminal 70 may optionally comprise one or more programmable logic circuits (FPGA, PLD, etc.), and/or one or more specialized integrated circuits (ASIC, etc.), and/or a set of discrete electronic components, etc., adapted to carry out all or part of the operations to be carried out by said user terminal. The user terminal 70 also comprises at least one communication module 73 for exchanging data with base stations 11 of the wireless cellular access network. The user terminal 70 is for example a mobile phone, a smartphone, a connected object, a laptop, a tablet, etc.

As illustrated in FIG. 6, the method 60 for configuration implemented by the user terminal 70 comprises the following steps:
S60 reception, by the communication module 73, of respective beam loads of one or more cells of the wireless cellular access network, for example beams in which the user terminal 70 is located and/or towards which it is moving; said beam loads are estimated by the wireless cellular access network by implementing the method 20 for estimation, and are transmitted to the user terminal 70 by one or more base stations 11,
S61 use of the estimated beam loads to configure communication with the wireless cellular access network.

For example, the configuration of communications by the user terminal 70 corresponds to using the estimated beam loads to manage the mobility of said user terminal 70, in particular to select one beam rather than another for the exchange of data with the wireless cellular access network. For example, the user terminal 70 may use one or more estimated beam loads:
within a context of a cell selection mechanism (procedure for initial access to the wireless cellular access network): when a user terminal 70 is turned on or finds a coverage area, it performs power measurements on beams transmitted by different cells in order to select the most suitable cell to serve it; in such a cell selection process, a user terminal 70 could also take into account the load of the beams in order to favor cells with lightly loaded beams,
within a context of a cell re-selection mechanism (mobility mechanism used when the user terminal 70 is in inactive mode): when a user terminal 70 is in inactive mode, it continues to perform periodic power measurements on beams transmitted by different cells tin order to periodically update the attachment of the user terminal 70 (identity of the cell with which the user terminal 70 will exchange data if it switches to connected mode); in such a cell re-selection process, a user terminal 70 could also take into account the load of the beams in order to favor cells with lightly loaded beams,
within a context of a cell change mechanism (mobility mechanism used when a user terminal is in connected mode: “handover”): in mobile networks, mobility mechanisms allow changing the attachment of user terminals 70 when they detect better radio conditions in a cell other than the one to which they are attached; using power measurements carried out periodically on the beams of different cells, the user terminals 70 can trigger events to allow initiating or interrupting a handover, and such events could also be triggered by taking into account beam load, etc.

1. A method for estimation, by a control device of a wireless cellular access network, of a load of a beam of interest among a plurality of beams that may be formed to serve user terminals in a cell of the wireless cellular access network, the method for estimation comprising:
determining a load indicator M_{E}(T) of the cell for a time window T, based on information regarding a use of communication resources throughout the cell, during the time window,
determining a load indicator M_{b}(T) of the beam of interest for the time window T, based on information concerning a use of communication resources in the beam of interest, during the time window, and
estimating the load of the beam of interest, based on the product M_{E}(T)×M_{b}(T).

2. The method for estimation according to claim 1, wherein determining the load indicator M_{b}(T) of the beam of interest for the time window T comprises determining a level of usage, in the beam of interest, of usable communication resources in the beam of interest during the time window.

3. The method for estimation according to claim 2, wherein determining the level of usage of the usable communication resources in the beam of interest during the time window takes into account time intervals during which the beam of interest is activated.

4. The method for estimation according to claim 1, wherein the wireless cellular access network uses orthogonal frequency-division multiple access, in which the usable communication resources correspond to physical resource blocks, called PRBs, and the load indicator M_{b}(T) of the beam of interest for the time window T is determined according to the following expression:
$${\sum }_{i = 1}^{L} {\text{?}}_{b}^{i} \frac{{N}_{PRB , b}^{i}}{{N}_{PRB , b}^{max , i}}$$
an expression in which:
$${\text{?}}_{b}^{i}$$
corresponds to an indicator function which is equal to 1 if the beam b of interest is activated in a time interval i of the time window, the time window comprising L time intervals, and which is otherwise equal to 0,
$${N}_{PRB , b}^{i}$$
corresponds to a number or PRBs used in the beam b of interest in the time interval i of the time window,
$${N}_{PRB , b}^{max , i}$$
corresponds to a maximum number of PRBs that can be used in the beam b of interest in the time interval i of the time window.

5. The method for estimation according to claim 1, wherein determining the load indicator M_{E}(T) of the cell for the time window T comprises determining a level of usage, in the cell, of usable communication resources in the cell during the time window.

6. The method for estimation according to claim 1, wherein the wireless cellular access network uses orthogonal frequency-division multiple access, in which the usable communication resources correspond to physical resource blocks, called PRBs, and the load indicator M_{E}(T) of the cell for the time window T is determined according to the following expression:
$$\frac{{\sum }_{f} f {\sum }_{i}^{L} {R}_{f , i} ( T )}{{\sum }_{i}^{L} {P}_{i} ( T ) LM ( T )}$$
an expression in which:
R_{f,i}(T) corresponds to a number of PRBs multiplexed by each of the f spatial streams over a time interval i of the time window, the time window comprising L time intervals,
Pᵢ(T) corresponds to a maximum number of PRBs that can be used over time interval i for a single spatial stream in the cell,
LM(T) corresponds to a temporal average, over the time window, of a maximum number of spatial streams that can be used.

7. The method for estimation according to claim 1,
wherein the wireless cellular access network uses orthogonal frequency-division multiple access, in which the usable communication resources correspond to physical resource blocks, called PRBs, and the load indicator M_{b}(T) of the beam of interest for the time window T is determined according to the following expression:
$${\sum }_{i = 1}^{L} {\text{?}}_{b}^{i} \frac{{N}_{PRB , b}^{i}}{{N}_{PRB , b}^{max , i}}$$
an expression in which:
$${\text{?}}_{b}^{ℓ}$$
N_{PRB,b}ⁱ corresponds to an indicator function which is equal to 1 if the beam b of interest is activated in a time interval i of the time window, the time window comprising L time intervals, and which is otherwise equal to 0,
corresponds to a number of PRBs used in the beam b of interest in the time interval i of the time window,
N_{PRB,b}^{max, i} corresponds to a maximum number of PRBs that can be used in the beam b of interest in the time interval i of the time window;
wherein the wireless cellular access network uses orthogonal frequency-division multiple access, in which the usable communication resources correspond to physical resource blocks, called PRBs, and the load indicator M_{E}(T) of the cell for the time window T is determined according to the following expression:
$$\frac{{\sum }_{f} f {\sum }_{i}^{L} {R}_{f , i} ( T )}{{\sum }_{i}^{L} {P}_{i} ( T ) LM ( T )}$$
an expression in which:
R_{f,i}(T) corresponds to a number of PRBs multiplexed by each of the f spatial streams over a time interval i of the time window, the time window comprising L time intervals,
Pᵢ(T) corresponds to a maximum number of PRBs that can be used over time interval i for a single spatial stream in the cell,
LM(T) corresponds to a temporal average, over the time window, of a maximum number of spatial streams that can be used;
wherein the load of the beam of interest is determined according to the following expression:
$$\frac{1}{K} ⌊ \frac{{\sum }_{f} f {\sum }_{i}^{L} {R}_{f , i} ( T )}{{\sum }_{i}^{L} {P}_{i} ( T ) LM ( T )} \times K ⌋ \times \frac{1}{L} {\sum }_{i = 1}^{L} {\text{?}}_{b}^{i} \frac{{N}_{PRB , b}^{i}}{{N}_{PRB , b}^{max , i}}$$
or according to the following expression:
$$\frac{{\sum }_{f} f {\sum }_{i}^{L} {R}_{f , i} ( T )}{{\sum }_{i}^{L} {P}_{i} ( T ) LM ( T )} \times \frac{1}{L} {\sum }_{i = 1}^{L} {\text{?}}_{b}^{i} \frac{{N}_{PRB , b}^{i}}{{N}_{PRB , b}^{max , i}}$$

8. A configuration method for configuration, by a control device of a wireless cellular access network, of communications with user terminals, the wireless cellular access network comprising base stations serving a plurality of cells, it being possible to form a plurality of beams in each cell, the configuration method for configuration comprising:
estimating, by implementing the method for estimation according to claim 1, of respective beam loads of cells of the wireless cellular access network, and
using the estimated beam loads to configure communications with user terminals.

9. The configuration method for configuration according to claim 8, wherein the estimated beam loads are used to perform at least one of the following:
managing the communication resources of the wireless cellular access network,
managing the mobility of user terminals,
distributing loads between beams of a same cell and/or between beams of different cells.

10. A computer program comprising a set of program code instructions which, when executed by at least one processor, configure the at least one processor to implement the method according to claim 1.

11. A control device comprising at least one memory and at least one processor configured to implement the method according to claim 1.

12. A first method for configuration, by a user terminal, of a communication with a wireless cellular access network comprising base stations serving a plurality of base station cells, it being possible to form a plurality of beams in each cell, the first method for configuration comprising:
receiving respective beam loads of one or more cells of the wireless cellular access network, the beam loads being estimated by implementing the method for estimation according to claim 1, and
using the estimated beam loads to configure the communication with the wireless cellular access network.

13. The first method for configuration according to claim 12, wherein the estimated beam loads are used for mobility management for the user terminal.

14. A computer program comprising a set of program code instructions which, when executed by at least one processor, configure the at least one processor to implement the first method according to claim 12.

15. A user terminal for exchanging data with a wireless cellular access network, the user terminal comprising at least one memory and at least one processor configured to implement the first method according to claim 12.

16. A computer program comprising a set of program code instructions which, when executed by at least one processor, configure the at least one processor to implement the configuration method according to claim 8.

17. A control device comprising at least one memory and at least one processor configured to implement the configuration method according to claim 8.
